(19) United States
(12) Patent Application Publication
(10) Pub. No.: US 2003/0056760 A1
(43) Pub. Date: Mar. 27, 2003

(54) High-pressure fuel accumulator

(76) Inventors: Helmut Knoedl, Marbach-Rielingshausen (DE); Henning Kreschel, Ludwigsburg (DE); Steffen Jung, Leonberg (DE)

Correspondence Address: KENYON & KENYON, ONE BROADWAY, NEW YORK, NY, 10004, US

(21) Appl. No.: 10/219,363

(22) Filed: Aug. 15, 2002

(30) Foreign Application Priority Data
Aug. 16, 2001 (DE) 101 40 057.8

(51) Int. Cl. F02M 1/00

(52) U.S. Cl. 123/456; 123/447

(57) ABSTRACT

A high-pressure fuel accumulator for a common-rail fuel injection system for internal combustion engines is provided, which includes a base body made of a base material having at least one connecting piece. In this context, the base body includes a longitudinal bore forming an interior chamber, and the at least one connecting piece includes at least one transverse bore opening out into the longitudinal bore. The interior chamber of base body includes a high-strength filler material in the region of the at least one transverse bore.

### FIELD OF THE INVENTION

The present invention relates to a high-pressure fuel accumulator for a fuel injection system of an internal combustion engine.

### BACKGROUND INFORMATION

A injection system is used to supply an internal combustion engine with fuel. In an accumulator fuel-injection system called a common rail system, pressure generation and injection are decoupled from each other both as to time and location. A separate high-pressure pump generates the injection pressure in a central high-pressure fuel accumulator. The beginning of injection and the quantity injected are determined by the activation instant and duration of electrically operated injectors, which are connected to the high-pressure fuel accumulator via fuel lines.

German Published Patent Application No. 199 36 533 relates to a high-pressure fuel accumulator for a common rail fuel injection system of an internal combustion engine, having a pipe-shaped base element which has a longitudinal blind-end bore and several connections.

A high-pressure fuel accumulator for a common rail fuel injection system of an internal combustion engine is described in German Published Patent Application No. 199 49 962. The high-pressure fuel accumulator has a hollow base body furnished with several connecting openings. The interior chamber of the base body has a flat configuration in the region of the connecting openings.

The high-pressure resistance of the high-pressure fuel accumulator is limited mainly by the faulty cuttings between the connecting openings and the base body. These faulty bore cuttings are powerfully stressed by the internal pressure, and represent possible failure locations of the high-pressure fuel accumulator. During operation, stress spikes appear there, whereby cracks in the base body may form.

### SUMMARY

The pressure resistance of a high-pressure fuel accumulator is increased in the present invention. This occurs due to a greater load capacity of the faulty bore cuttings between the longitudinal bores in the base body of the high-pressure fuel accumulator and the transverse bores in its pipe connecting piece.

According to the present invention, the pressure resistance is achieved by a high-pressure fuel accumulator for a common rail fuel injection system for an internal combustion engine which includes a base body, made of a base substance, having at least one connecting piece. The base body includes a longitudinal bore forming an interior chamber, and the at least one connecting piece includes at least one transverse bore opening out into the longitudinal bore. The interior of the base body includes a high-strength filler material in the region of the at least one transverse bore.

By the selective introduction of the high-strength filler material in the region of the faulty bore cuttings, which represent the weak spot of the high-pressure fuel accumulator, a cost-effective, low-strength material may be selected, such as steel for example, as the base material for the remaining base body.

In an exemplary embodiment of the present invention, the high-strength filler material contains at least one material from the group of iron materials, ceramic materials and composite materials.

### BRIEF DESCRIPTION OF THE DRAWINGS

FIG. 1 is a cross-sectional view through the high-pressure fuel accumulator having an inlet part.

FIG. 2 is a cross-sectional view through the high-pressure fuel accumulator having an insert part.

FIG. 3.1 is a cross-sectional view of an example embodiment of an inserted filler material in a high-pressure fuel accumulator.

FIG. 3.2 is a cross-sectional view of another example embodiment of an inserted filler material in a high-pressure fuel accumulator.

FIG. 3.3 is a cross-sectional view of yet another example embodiment of an inserted filler material in a high-pressure fuel accumulator.

### DETAILED DESCRIPTION

FIG. 1 illustrates a cross-sectional view through a high-pressure fuel accumulator having an inlet part made of a high-strength filler material according to the present invention.

The high-pressure fuel accumulator illustrated in cross-section includes a base body 1 made of a base material, in which longitudinal bore 2 forms an interior chamber. A connecting piece 3 is formed on base body 1 in which a transverse bore 4 extends perpendicularly to longitudinal bore 2. The transverse bore opens out into longitudinal bore 2. Fuel lines lead to the individual injectors which inject the fuel into the combustion chamber of the internal combustion engine, via connecting piece 3. In the region of the interior chamber of base body 1, in which there is the faulty cutting of longitudinal bore 2 and transverse bore 4, base body 1 includes an inlet part 5 made of a high-strength filler material. This reinforces the region of faulty cutting of the bores, in order to prevent the formation of cracks in this region, caused by stress peaks.

In this specific example embodiment of the present invention, the base body includes the filler material in the form of at least one inlet part 5. In this context, an inlet part 5 is defined as a part made of the filler material which is inserted into a recess in the base body's base material. Thereby it replaces by at least a part of its volume the base material of base body 1 which has already undergone the application of longitudinal bore 2. Inlet part 5 may extend partially into the cylindrical interior chamber created by longitudinal bore 2, and reduce its volume.

In one specific exemplary embodiment of the present invention, each inlet part 5 surrounds a respective transverse bore 4 at the end of transverse bore 4 facing the interior chamber of base body 1. In this connection, the high-strength filler material is purposefully, and in a cost-saving manner, inserted only in the region of the faulty cutting of the bores that is highly stressed during the operation of the high-pressure fuel accumulator. It may, for example, have twice the diameter of transverse bore 4.

In the specific exemplary embodiment of the present invention illustrated in FIG. 1, the interior chamber of base body 1 in the region of the at least one transverse bore 4 is formed flat by the filler material. Here, inlet part 5 forms a flat area 6 in the originally cylindrical interior chamber of base body 1. Flat area 6 extends in a perpendicular manner to center line 7 of transverse bore 4 and parallel to the center line of longitudinal bore 2. In this context, the stress peaks in the region of the faulty cutting of the bores are minimized. The greater the ratio of the inner diameter of base body 1 to the inner diameter of transverse bore 4, the greater is the resistance to pressure of the high-pressure fuel accumulator. An infinitely great inner diameter of the base body is simulated by flat area 6 in the interior chamber of base body 1 in the region of transverse bore 4, and thereby the pressure resistance of the high-pressure fuel accumulator is maximized in this region.

In the specific exemplary embodiment of the present invention illustrated in FIG. 1, inlet part 5 has a quadrangular cross-section. In this case, a cross-section of inlet part 5 in the form of a rectangle is involved.

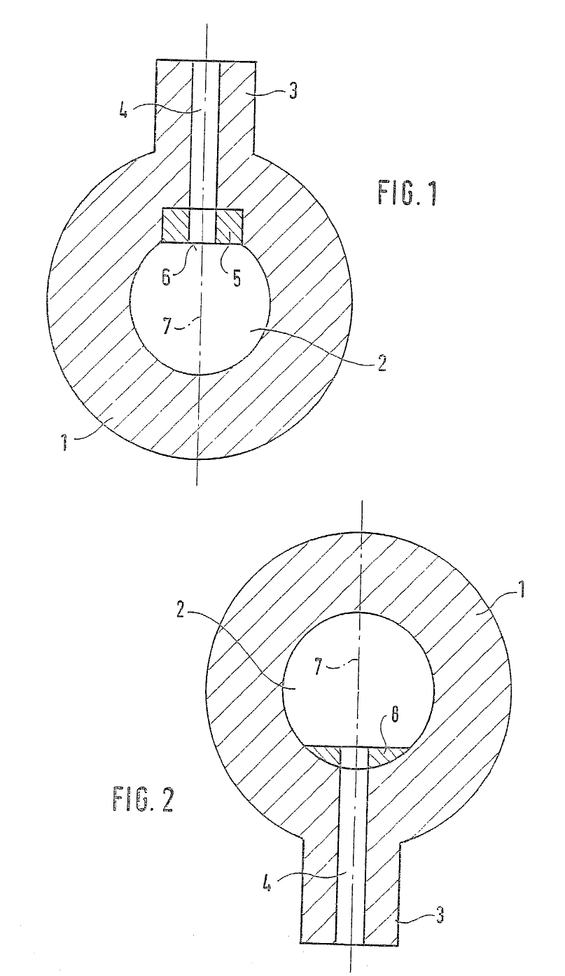

FIG. 2 illustrates the cross-section through a high-pressure fuel accumulator according to the present invention having an inserted part made of a high-strength filler material.

The high-pressure fuel accumulator shown in cross-section includes (analogously to FIG. 1) a base body 1, made of a base material, having a connecting piece 3. Base body 1 contains longitudinal bore 2, and connecting piece 3 contains the at least one transverse bore 4. In this specific exemplary embodiment of the present invention, the filler material in base body 1 is present in the form of an insert part 8. In this connection, insert part 8 may be an additional part which is inserted into the interior chamber present because of longitudinal bores 2 in base body 1. Insert part 8 reduces the volume of the cylindrical interior chamber of base body 1, generated by longitudinal bore 2.

In another exemplary embodiment of the present invention, one insert part 8 made of high-strength filler material surrounds one respective transverse bore 4 at the end of transverse bore 4 facing the interior chamber of base body 1. In another exemplary embodiment of the present invention, an insert part 8 surrounds the ends of all transverse bores 4 facing the interior chamber of base body 1. In this connection, insert part 8 may extend along the entire longitudinal bore 2 or along a major part of its length.

In the exemplary embodiment of the present invention illustrated in FIG. 2, the interior chamber of base body 1 in the region of the at least one transverse bore 4 is formed flat by insert part 8. This has the result, for reasons already mentioned, of a maximum pressure resistance of the high-pressure fuel accumulator in the region of faulty cutting of longitudinal and transverse bores.

In the exemplary embodiment of the present invention illustrated in FIG. 2, insert part 8 has a cross-section in the form of a circular section.

Furthermore, the present invention relates to a method for producing a high-pressure fuel accumulator in which the filler material (in the form of an inlet part 5 or an insert part 8) is inserted into the interior chamber of base body 1 by using a thermal bonding method. The filler material may, for instance, be joined to the base material of base body 1 by soldering or welding. The filler material may be installed in a molten state, which subsequently cools in the interior chamber of base body 1 and hardens.

In a further exemplary method according to the present invention for producing a high-pressure fuel accumulator according to the present invention, the filler material (in the form of an inlet part or insert part) is inserted into the interior chamber of the base body by adhesion.

A force-locking insertion of the filler material into the interior chamber of base body 1 may also be accomplished, such as by pressing in an inlet part. The filler material may also be joined to the base material of base body 1 by sintering.

The inlet part or the insert part may, even before insertion into the interior chamber, surround bores which form a continuous opening with transverse bores 4 after their insertion. The transverse bores may be drilled through the connecting pieces and through the filler material only after insertion of the filler material. This allows the bores to lie exactly one over the other, and that the bores may be prepared in just one work step.

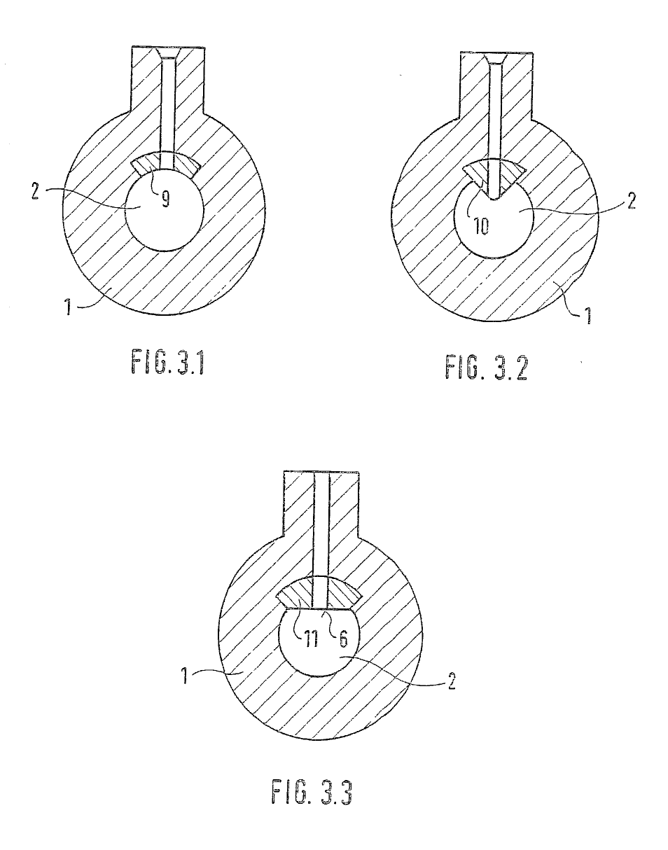

FIGS. 3.1-3.3 illustrate various forms of the inserted filler material in a high-pressure fuel accumulator according to the present invention. In FIG. 3.1 an inlet part 9 is illustrated, which in cross-section has the shape of a circular ring. In this specific exemplary embodiment of the present invention, inlet part 9 does not extend into the cylindrical interior chamber generated by longitudinal bore 2.

FIG. 3.2 illustrates a high-pressure fuel accumulator according to the present invention having an inlet part 10, which has a cross-section in the shape of a sector of a circle, and which partially extends into the interior chamber of base body 1 generated by longitudinal bore 2.

FIG. 3.3 illustrates a high-pressure fuel accumulator according to the present invention having an inlet part 11. Inlet part 11 has a cross-section which has a shape which represents a combination of a circular ring part and a circular section, the circular section-shaped part of inlet part 11 extending into the interior chamber of base body 1 generated by longitudinal bore 2. In this exemplary embodiment, the inlet part 11 may form a flat surface 6 in the originally cylindrical interior chamber of base body 1, and thereby the pressure resistance of the high-pressure fuel accumulator is maximized in the region of the faulty cutting of the bores.

What is claimed is:

1. A high-pressure fuel accumulator for a common-rail fuel injection system of an internal combustion engine, comprising:
a base body made of a base material, the base body having at least one connecting piece and a longitudinal bore configured to form an interior chamber, the at least one connecting piece having at least one transverse bore opening into the longitudinal bore, wherein the interior of the base body includes a high-strength filler material in a region of the at least one transverse bore.

2. The high-pressure fuel accumulator according to claim 1, wherein the high-strength filler material contains at least one material from a group of iron materials, ceramic materials and composite materials.

3. The high-pressure fuel accumulator according to claim 1, wherein the filler material in the base body is in a form of at least one inlet part.

4. The high-pressure fuel accumulator according to claim 3, wherein the at least one inlet part surrounds one transverse bore.

5. The high-pressure fuel accumulator according to claim 3, wherein the at least one inlet part surrounds a plurality of transverse bores.

6. The high-pressure fuel accumulator according to claim 3, wherein a cross section of the inlet part has a shape selected from a group of circular sections, sectors of circles, circular ring parts and quadrangles.

7. The high-pressure fuel accumulator according to claim 1, wherein the filler material in the base body is in a form of at least one insert part.

8. The high-pressure fuel accumulator according to claim 1, wherein in the region of the at least one transverse bore, the interior chamber of the base body is imparted a flat profile by the filler material.

9. A method for producing a high-pressure fuel accumulator, comprising:
providing a base body made of a base material for the fuel accumulator, the base body having at least one connecting piece and a longitudinal bore configured to form an interior chamber, the at least one connecting piece having at least one transverse bore opening into the longitudinal bore; and
inserting a high-strength filler material into the interior chamber of the base body in a region of the at least one transverse bore by a thermal insertion method.

10. A method for producing a high-pressure fuel accumulator, comprising:
providing a base body made of a base material for the fuel accumulator, the base body having at least one connecting piece and a longitudinal bore configured to form an interior chamber, the at least one connecting piece having at least one transverse bore opening into the longitudinal bore; and
inserting a high-strength filler material into the interior chamber of the base body in a region of the at least one transverse bore by adhesion method.

11. The method for producing a high-pressure fuel accumulator, comprising:
providing a base body made of a base material for the fuel accumulator, the base body having at least one connecting piece and a longitudinal bore configured to form an interior chamber, the at least one connecting piece having at least one transverse bore opening into the longitudinal bore; and
inserting a high-strength filler material into the interior chamber of the base body in a region of the at least one transverse bore by force-locking method.
